(19) United States
(12) Patent Application Publication
(10) Pub. No.: US 2017/0319907 A1
(43) Pub. Date: Nov. 9, 2017

(54) METHOD AND APPARATUS FOR SAFELY ASCENDING A UTILITY TOWER

(71) Applicant: John Crawford, Scottsdale, AZ (US)

(72) Inventor: John Crawford, Scottsdale, AZ (US)

(21) Appl. No.: 15/493,792

(22) Filed: Apr. 21, 2017

Related U.S. Application Data
(60) Provisional application No. 62/331,950, filed on May 4, 2016.

(51) Int. Cl. A63B 27/02; F16B 45/02; A62B 35/00

(52) U.S. Cl. CPC A63B 27/02; A62B 35/0037; F16B 45/02

(57) ABSTRACT

A support tower is equipped with a plurality of step-bolts, each of which comprises (1) a threaded portion that is attached to a pre-existing hole in the tower and (2) a shaft portion that extends outward from the tower. The shaft portion of each of the step-bolts includes an undercut section that is sized to match (with minimal clearance) the throat of a corresponding carabiner, which is attached to a safety harness worn by the user. The remainder of the shaft portion of the step-bolt is larger in diameter than the throat of the carabiner so that the carabiner cannot slide out toward the free end of the step-bolt.

This application claims priority of U.S. Provisional Patent Application 62/331,950 filed on May 4, 2016.

### BACKGROUND OF THE INVENTION

This invention relates generally to the repair and maintenance of utility towers, radio and cell phone towers, telephone poles, utility poles and the like and, in particular, to methods and apparatus for the safe ascending and descending of such towers and poles by linemen, repairmen and others.

It is well-known in the art to attach a series of step-bolts to utility towers, utility pylons, radio towers, cell phone towers, telephone poles, utility poles and the like (hereinafter collectively referred to as a “support tower” or simply “tower”) to provide a foot purchase and/or hand grip for a lineman, repairman or other authorized individual to use to ascend the tower. A conventional step-bolt, however, is typically nothing more than a cylindrical bolt between ⅝″ and ¾″ in diameter, with an enlarged head approximately 2″ in diameter, similar to the head of a carriage bolt, which acts as a stop to prevent the lineman's foot from slipping off the end of the step-bolt.

Historically, lineman and communications tower workers would ascend a utility tower by free climbing without any safety strap or harness, since this is the fastest way to ascend and descend the tower. However, in the aftermath of an epidemic of cell phone tower deaths (13 deaths in 2013 and 11 deaths in 2014), OSHA and the communications industry have begun to focus on methods of improving the safety of communications tower workers. Similar efforts to improve worker safety are underway in the power transmission industry. One method that has been implemented to improve worker safety is to provide the worker with a wearable safety harness, which can be attached to the tower step-bolts using a lanyard with a carabiner attached to the end. Unfortunately, most common carabiners are designed primarily to attach to a D-ring or overhead cable, rather than to a cantilevered step-bolt. Therefore, a typical carabiner that has a gap between the nose and gate sufficient to accommodate a ¾″ bolt will also have a basket that is larger than the 2-inch diameter head of a standard step-bolt. Finally, a standard step-bolt, while adequate to support the weight of a 95th percentile male when climbing, will yield and bend downward under the shock load of a falling worker, especially if the carabiner has moved to the extreme free end of the step-bolt, where the moment arm for the shock load is greatest. These two defects could result in a carabiner slipping off the end of the step-bolt with potentially disastrous consequences.

It is also cumbersome to use a conventional carabiner since the gate must be manipulated by hand (typically by holding the carabiner with one hand and pulling and twisting the gate with the other hand) each time the carabiner is moved. Accordingly, many linemen and communications workers prefer a purpose-built carabiner and safety lanyard such as the “Step Safe Lanyard 2002” sold by Total Access (UK) Ltd, Eccleshall UK. The Step Safe lanyard has a gate and lock that can both be manipulated with a single hand. It also has a basket (throat) that is sized to closely-match the diameter of a step-bolt (i.e. ⅝″ and ¾″ in diameter) and therefore should not slip off the end of the step-bolt, even if the step-bolt yields and bends downward. The Safe Step lanyard does not, however, have any way of preventing the carabiner from moving to the free end of the step-bolt where the bending moment arm is greatest.

What is needed therefore, is the combination of a purpose-built carabiner, and a step-bolt configured to prevent the carabiner from sliding to the outer end of the step-bolt. Preventing the carabiner from sliding outward results in reduced bending loads on the step-bolt during a fall arrest, eliminating the possibility that the step-bolt will bend downward (or fail completely).

### SUMMARY OF THE INVENTION

The present invention solves the foregoing problem by providing a tower equipped with a plurality of step-bolts, and a method of using the step-bolts to safely ascend or descend a tower using a carabiner attached to a safety lanyard. According to an illustrative embodiment, each of the step-bolts comprises a threaded portion that attaches to pre-existing holes in the tower and a shaft portion that extends outward from the tower. The shaft portion of each of the step-bolts includes an undercut section that is sized to match (with minimal clearance) the throat of the carabiner, while the remainder of the shaft portion is larger in diameter than the throat of the carabiner. In one embodiment, the undercut section is centered about the midpoint of the shaft portion of the step-bolt, which prevents the carabiner from sliding out toward the end of the step-bolt when attached. In another embodiment, the undercut section is offset inward from the midpoint of the shaft portion to further reduce the bending moment arm of the carabiner on the step-bolt during a fall arrest. According to an illustrative method, a support tower is provided with the step-bolts as described above. The user ascends and descends the tower by attaching the carabiner to the undercut region of one step-bolt while stepping on another of the step-bolts. In another embodiment, a tower is provided with bolts having an undercut region as described above, but which are too short to step on. These short step-bolts (referred to hereinafter as carabiner bolts) are used solely for the purpose of attaching the carabiner. Other step-bolts, including conventional step-bolts, are used to support the user's weight in the normal course of ascending and descending the tower in conjunction with the carabiner bolts.

The step-bolts and carabiner bolts may include a base flange between the threads and the shaft. Use of a base flange significantly reduces the bending stress at the junction between the shaft and the tower wall. A tip flange may also be included to help prevent the user's foot from slipping off the end of the step-bolt. Optionally, the base flange is blended smoothly into the shaft and the shaft is blended smoothly into the undercut section in order to reduce stress concentrations.

### BRIEF DESCRIPTION OF THE DRAWING

The present invention will be better understood from a reading of the following detailed description, taken in conjunction with the accompanying drawing figures in which like references designate like elements and, in which:

FIG. 1 is a perspective view of a pair of utility transmission towers having step-bolts incorporating features of the present invention;

FIG. 2 is a side view of a step-bolt incorporating features of the present invention;

FIG. 3 is a perspective view of a carabiner prior to being attached to the step-bolt of FIG. 2;

FIG. 4 is a perspective view of a carabiner after being attached to the step-bolt of FIG. 2;

FIG. 5 is a cross sectional view of a carabiner attached to the step-bolt of FIG. 2;

FIG. 6 is a perspective view of a lineman ascending a tower in accordance with a method incorporating features of the present invention; and

FIG. 7A-7D are cross-sectional views of alternative embodiments of a step-bolt incorporating features of the present invention.

### DETAILED DESCRIPTION

The drawing figures are intended to illustrate the general manner of construction and are not necessarily to scale. In the detailed description and in the drawing figures, specific illustrative examples are shown and herein described in detail. It should be understood, however, that the drawing figures and detailed description are not intended to limit the invention to the particular form disclosed, but are merely illustrative and intended to teach one of ordinary skill how to make and/or use the invention claimed herein and for setting forth the best mode for carrying out the invention.

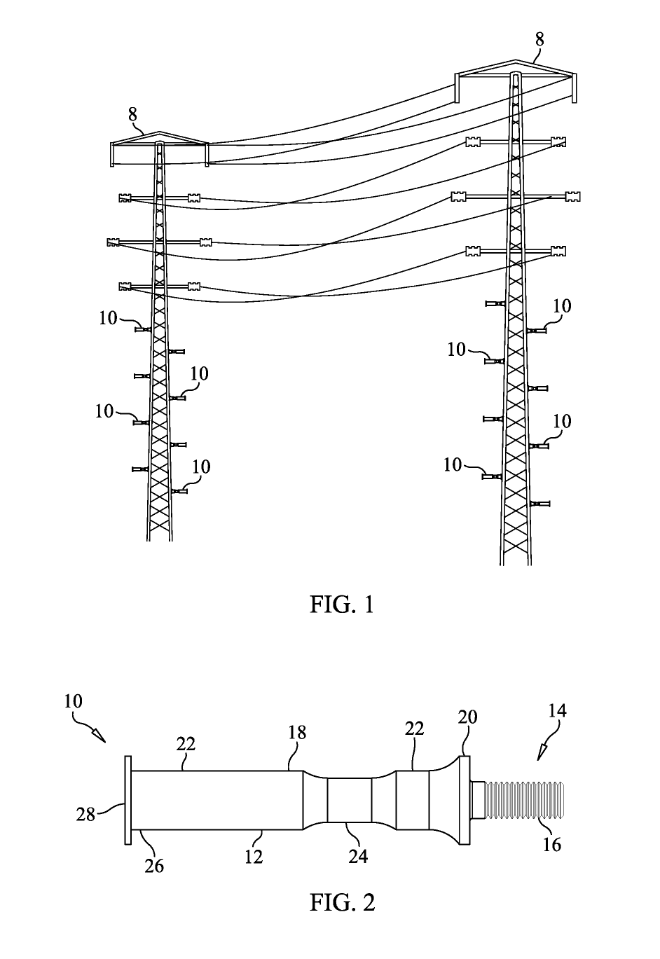

With reference to the drawing figures, FIG. 1 is an illustration of a pair of support towers 8 of the type typically used by power companies for transmission of electric power. In accordance with the invention, support towers 8 include a plurality of step-bolts 10, which are threaded into threaded apertures in support towers 8. Step-bolts 10 are spaced apart along the length of the tower to provide a foot purchase and/or hand grip for a lineman, repairman or other authorized individual to use to ascend and descend the tower.

With additional reference to FIG. 2, each of step-bolts 10 comprises a solid substantially cylindrical elongate body 12, preferably machined, cast, rolled or otherwise formed from a solid round bar of steel, aluminum, titanium or other suitable material. One end 14 of body 12 comprises an attachment means, which in the illustrative embodiment comprises a threaded portion 16, typically with ⅝″ or ¾″ male UNC threads to match the existing apertures in support tower 8. Step-bolt 10 may be secured to tower 8 by threading into a threaded aperture formed in tower 8 or may be secured by a corresponding nut, where it is possible to access the back side of the aperture with a wrench. Thread size and the method of attachment should not, however, be considered a limitation of the invention. Other means of attachment, including for example, insertion of an enlarged head portion of end 14 into a vertical keyhole slot, forming female threads in end 14, and press/shrink interference fit are all considered attachment means within the scope of the invention.

Body 12 further includes a shaft portion 18 extending away from threaded portion 16. A base flange 20 approximately 0.175 inches thick and having an outside diameter of 1½ inches separates shaft portion 18, from threaded portion 16. Base flange 16 provides a large bearing surface between step-bolt 10 and support tower 8 to reduce the potential bending stresses on step-bolt 10 in a fall-arrest situation. Shaft portion 18 includes an enlarged section 22 and an undercut region 24, the purpose of which will be explained in further detail hereinafter. Undercut region 24 is offset toward base flange 20 relative to the full length of shaft portion 18. The free end 26 of step-bolt 10 terminates at a tip flange 28 approximately ¼ inch thick by 1½ inches in diameter. Tip flange 28 provides a conventional stop to prevent a user's foot from sliding off the free end 26 of step-bolt 10.

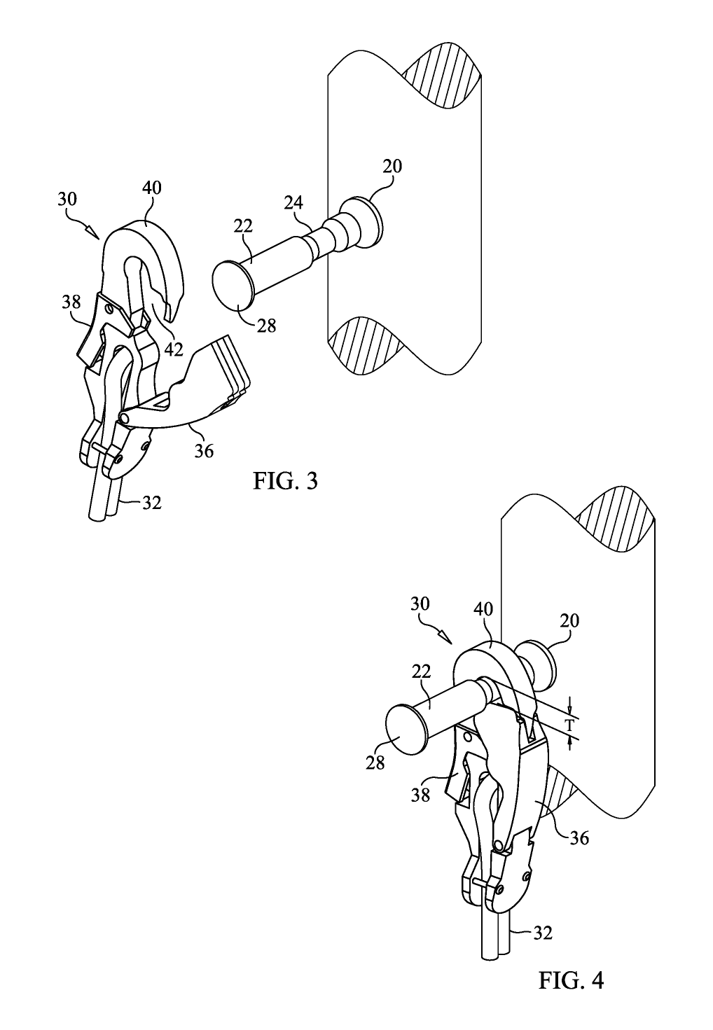

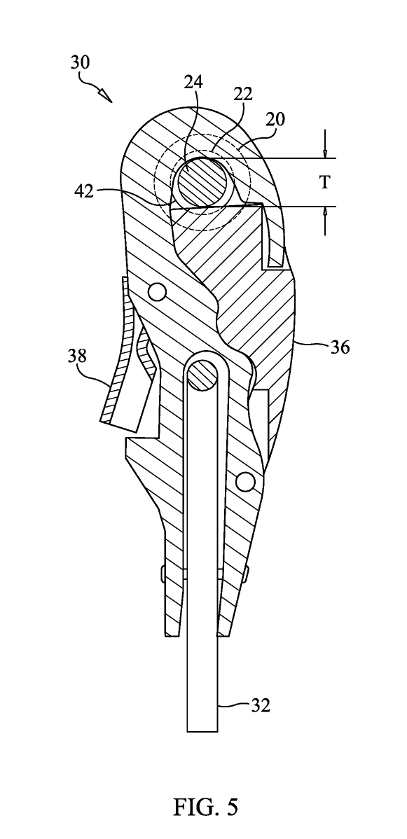

With additional reference to FIGS. 3-7, a carabiner 30 is provided, along with a shock absorbing lanyard 32 and safety harness 34. The carabiner may be of any design, but preferably is the type that can be manipulated by a single hand, such as the “Step Safe Lanyard 2002” sold by Total Access (UK) Ltd, Eccleshall UK. Carabiner 30 includes a gate 36, a lock 36 and a basket 40 having a throat 42. In the illustrative embodiment, with gate 36 closed, throat 42 has a dimension “T” of slightly more than 3/4 inches as is necessary to attach it to a standard ¾ inch step-bolt. Undercut region 24 of step-bolt 10, therefore, is machined to approximately the same diameter as a standard 3/4 inch step-bolt for compatibility with carabiner 30. Enlarged section 22 is machined to approximately 1 inch in diameter. This enables enlarged section 22 to provides a surface that prevents carabiner 30 from moving outside of undercut region 24.

Although in the illustrative embodiment, dimension “T” is slightly more than ¾ inches, in practice, the diameter of undercut region 22 should be 0.005 to 0.200 inches, preferably 0.010 to 0.100 inches and most preferably about 0.050 less than the actual dimension “T” of the corresponding carabiner, irrespective of the nominal throat dimension of the carabiner. Similarly, although in the illustrative embodiment the diameter of enlarged section 22 is 1 inch, in practice enlarged section can be any diameter that is larger than dimension “T” by a sufficient amount (e.g. 0.050″-0.100″) to prevent carabiner 30 from moving outside of undercut region 24.

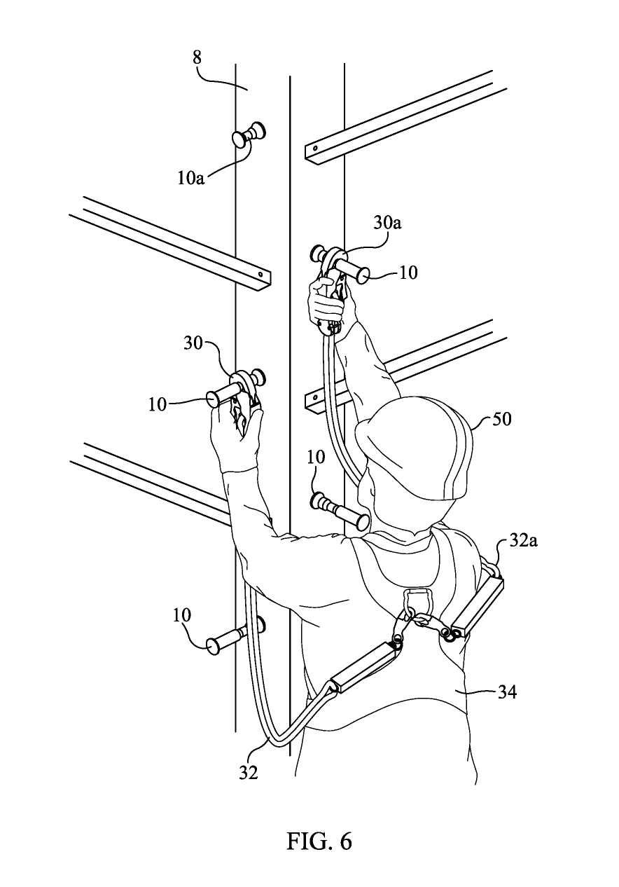

With particular reference to FIG. 6, in accordance with a method incorporating features of the present invention, a lineman, communications worker or other user 50 ascends tower 8 by attaching a carabiner 30 to one of the step-bolts 10 as hereinbefore described. The undercut region 24 in combination with the enlarged section 22 retain carabiner 30 in the undercut region adjacent to the base flange 20 of step-bolt 10. This ensures that in the event of a fall, the bending stresses on step-bolt 10 will be minimized. Once the carabiner 30 is attached to a step-bolt, the user 50 can ascend the tower by stepping onto a different one of the step-bolts 10 and then attaching carabiner 30a to yet another step-bolt. This process is repeated until the user 50 has ascended the tower to the desired location and repeated in reverse as the user 50 descends the tower. In an alternative embodiment, carabiner bolts 10a are provided for attaching carabiner 30 to tower 8. Carabiner bolts are made intentionally too short for user 50 to step on, but are used in conjunction with step-bolts 10, or conventional step-bolts, to provide an attachment point for carabiner 30, while step-bolts 10, or conventional step-bolts are used for foot and/or hand purchase during ascent and descent.

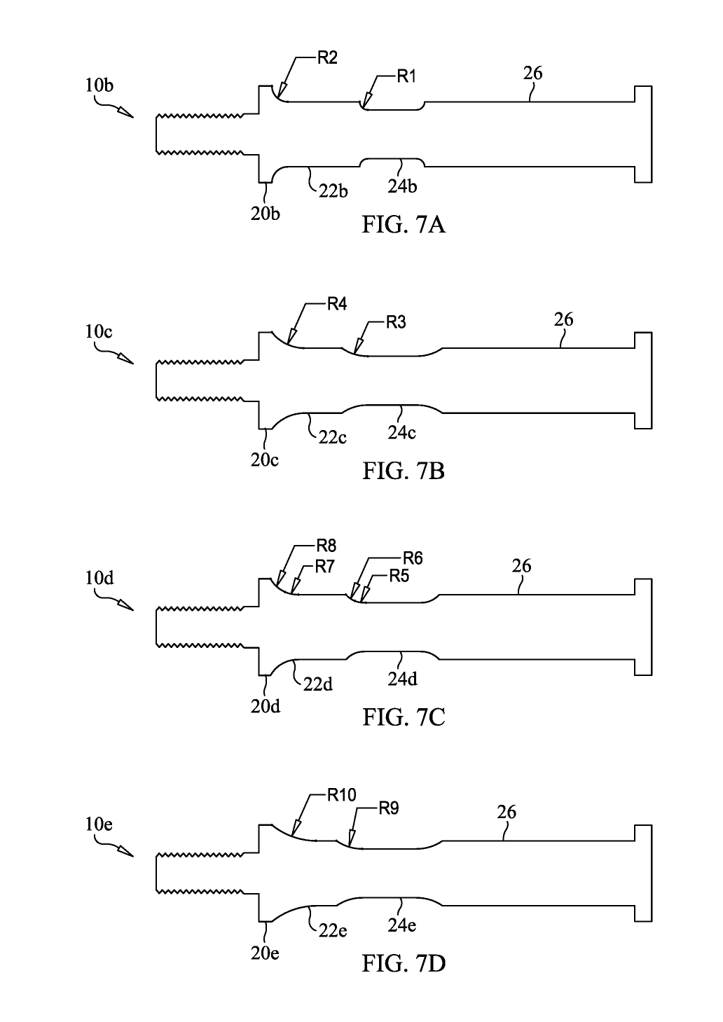

As can be determined from the foregoing, a major consideration in the design of a step-bolt is reducing the bending stress in the step-bolt during a fall arrest. Consequently, the inventor of the present invention determined that it would be important to reduce stress concentrations Kₜ especially in the portions of the step-bolt that would be supporting the user in a fall. With reference to FIG. 7A, step-bolt 10b includes a fillet having a radius R1 which forms a 90-degree arc between undercut section 24b and enlarged region 22b and a fillet having a radius R2, which forms a 90-degree arc between enlarged region 22b and base flange 20b. These radii are relatively small and, therefore, have a relatively high stress concentration factor Kₜ. With reference to FIG. 7B, step-bolt 10c includes a fillet having a radius R3 between undercut section 24b and enlarged region 22c and a fillet having a radius R4, between enlarged region 22c and base flange 20c. R3 and R4 do not form 90 degree arcs and therefore are larger than R1 and R2. The increase in radius results in a decrease in the stress concentration factor Kₜ. With reference to FIG. 7C, step-bolt 10d includes a fillet having a blended radius R5 and R6 between undercut section 24d and enlarged region 22d and a fillet having a blended radius R7 and R8, between enlarged region 22d and base flange 20d. R6 is larger than R5 and R8 is larger than R7. The compound curve resulting from the blended radii further decreases the stress concentration factor Kₜ relative to a fillet having a constant radius. Finally, with reference to FIG. 7D, step-bolt 10e includes a fillet between undercut section 24e and enlarged region 22e. The fillet has an elliptical profile, so that the radius R9 is continuously decreasing moving axially inward from undercut section 24e toward enlarged section 22e. Step-bolt 10e further includes a fillet between enlarged region 22e and base flange 20e. The fillet has an elliptical profile, so that the radius R10 is continuously decreasing moving axially inward from enlarged section 22e to base flange 20e. This results in still further decrease in the stress concentration factor Kₜ. A fillet may also optionally be provided between undercut region 24 and enlarged region 22 at the free end as shown in FIGS. 7A-7D, although a sharp transition at the free end of undercut region 24 may be more effective in preventing carabiner 30 from sliding outward along shaft 18.

Although certain illustrative embodiments and methods have been disclosed herein, it will be apparent from the foregoing disclosure to those skilled in the art that variations and modifications of such embodiments and methods may be made without departing from the invention. For example, although in the illustrative embodiment, the support tower is a power transmission tower, the support tower can be any utility pole, radio tower, or other vertical structure that can be climbed by a utility worker or other user. Similarly, although the illustrative embodiment discloses a bolt that is machined from a solid billet of material, the invention is not limited to a unitary bolt, but could be made from multiple pieces, such as a threaded rod that is threaded, pressed or otherwise attached to the elongate shaft portion. Additionally, although in the illustrative embodiment undercut region 24 is offset toward base flange 20 relative to the full length of shaft portion 18, undercut region 20 could be centered relative to the full length of shaft portion 18, or even offset toward the free end 26 of shaft portion 18. Accordingly, it is intended that the invention should be limited only to the extent required by the appended claims and the rules and principles of applicable law.

As used herein, references to direction such as “up” or “down” as well as recited materials or methods of attachment are intended to be exemplary and are not considered as limiting the invention and, unless otherwise specifically defined, the terms “generally,” “substantially,” or “approximately” when used with mathematical concepts or measurements mean within ±10 degrees of angle or within 10 percent of the measurement, whichever is greater. As used herein, a step of “providing” a structural element recited in a method claim means and includes obtaining, fabricating, purchasing, acquiring or otherwise gaining access to the structural element for performing the steps of the method. As used herein, the claim terms are to be given their broadest reasonable meaning unless a clear disavowal of that meaning appears in the record in substantially the following form (“As used herein the term ______ is defined to mean ______”)

1. A method of ascending a support tower comprising:
providing a support tower having first and second step-bolts attached to the support tower so that said first and second step-bolts extend substantially horizontally away from the support tower, said first and second step-bolts each comprising a generally elongate body having a first end and a second end, the first end comprising means for attaching to a corresponding location of the support tower, the second end comprising an elongate shaft portion extending away from the first end and terminating in a free end, the elongate shaft portion comprising an enlarged section, an undercut region and a tip flange each having a predetermined diameter and axial length, the diameter of the undercut region being less than the diameter of the enlarged section, the diameter of the enlarged section being less than the diameter of the tip flange, the axial length of the undercut region being greater than the axial length of the tip flange and the axial length of the enlarged section being greater than the axial length of the undercut region;
providing a safety harness and a carabiner attached to the safety harness, the carabiner having a throat with a predetermined dimension, the predetermined dimension of the throat being smaller than the diameter of the enlarged section of the elongate shaft portion; and
attaching the carabiner to the first step-bolt by engaging the throat of the carabiner with the undercut region of the step-bolt.

2. The method of claim 1, further comprising:
stepping onto the second step-bolt to ascend the support tower.

3. The method of claim 1, wherein:
the predetermined dimension of the throat is substantially equal to the diameter of the undercut region.

4. The method of claim 1, wherein:
the predetermined dimension of the throat is 0.005 to 0.100 larger than the diameter of the undercut region.

5. The method of claim 1, wherein:
the step-bolt further comprises a base flange disposed between the first end and the elongate shaft portion, the base flange having a diameter that is larger than the diameter of the elongate shaft portion.

6. (canceled)

7. The method of claim 1, wherein:
the undercut region is centered about a mid-point of the step-bolt.

8. The method of claim 1, wherein:
the undercut region is offset relative to a mid-point of the step-bolt.

9. The method of claim 1, wherein:
the diameter of the undercut region is blended into the diameter of the elongate shaft portion with a 90-degree fillet.

10. The method of claim 1, wherein:
the diameter of the undercut region is blended into the diameter of the elongate shaft portion with an ogival fillet.

11. The method of claim 1, wherein:
the diameter of the undercut region is blended into the diameter of the elongate shaft portion with a fillet comprising two arcs having different radii.

12. The method of claim 1, wherein:
the diameter of the undercut region is blended into the diameter of the elongate shaft portion with a fillet comprising two elliptical splines that are tangent to the surface of the step-bolt at their smallest circumference.

13. The method of claim 1, wherein:
the diameter of the elongate shaft portion is blended into the diameter of the base flange with a 90-degree fillet.

14. The method of claim 1, wherein:
the diameter of the elongate shaft portion is blended into the diameter of the base flange with an ogival fillet.

15. The method of claim 1, wherein:
the diameter of the elongate shaft portion is blended into the diameter of the base flange with a fillet comprising two arcs having different radii.

16. The method of claim 1, wherein:
the diameter of the elongate shaft portion is blended into the diameter of the base flange with a fillet comprising two elliptical splines that are tangent to the surface of the step-bolt at their smallest circumference.

17. In combination with a support tower, a step-bolt comprising:
a generally elongate body having a first end and a second end, the first end comprising means for attaching to a corresponding location of the support tower, the second end comprising an elongate shaft portion extending away from the first end and terminating in a free end, the elongate shaft portion comprising an enlarged section, an undercut region and a tip flange each having a predetermined diameter and axial length, the diameter of the undercut region being less than the diameter of the enlarged section, the diameter of the enlarged section being less than the diameter of the tip flange, the axial length of the undercut region being greater than the axial length of the tip flange and the axial length of the enlarged section being greater than the axial length of the undercut region.

18. The step-bolt of claim 17, further comprising:
a base flange disposed between the first end and the elongate shaft portion, the base flange having a diameter that is larger than the diameter of the elongate shaft portion.
